(19) United States
(12) Patent Application Publication
(10) Pub. No.: US 2024/0199371 A1
(43) Pub. Date: Jun. 20, 2024

(54) MECHANICAL BRAKE OPERATOR SYSTEM FOR LINEAR MOTOR ELEVATORS

(71) Applicants: DESIRD TASARIM ARGE ANONIM SIRKETI, Muratpasa, Antalya (TR); LINEARITY CO., LTD., Kyoto (JP)

(72) Inventors: Ender KAZAN, Muratpasa, Antalya (TR); Ahmet ONAT, Istanbul (TR); Sandor Andras MARKON, Kyoto (JP)

(21) Appl. No.: 18/556,936

(22) PCT Filed: Dec. 28, 2021
(86) PCT No.: PCT/TR2021/051544

§ 371 Date: Oct. 24, 2023

(51) Int. Cl. B66B 1/36; B66B 5/18; B66B 11/04

(52) U.S. Cl. CPC B66B 1/365; B66B 5/18; B66B 11/0407

(57) ABSTRACT

The invention relates to a mechanical brake operator system suitable for linear motor elevators providing low-cost and reliable braking without the need of power transmission for rope-less linear motor elevators. The mechanical brake operator system is also used by single-car or multi-car linear motor elevators operating on linear, curved, or branching trajectories.

### TECHNICAL FIELD

The invention relates to a mechanical brake operator system suitable for linear motor elevators providing low-cost and reliable braking without the need of power transmission for rope-less linear motor elevators. The mechanical brake operator system is also used by single-car or multi-car linear motor elevators operating on linear, curved, or branching trajectories.

### THE STATE OF ART

Rope-less linear motor elevators, being self-propelled, offer various benefits such as the capability of operating several elevators independently in the same hoist way, and potentially operating in curved travel paths. On the other hand, the traditional method of supplying power through wired connections in the “traveling cable” is no longer available, and suitable methods must be developed to supply the power needed for lighting, ventilation, door operation etc. in the cabin.

One of the devices that would need a stable power supply and reliable signal connection is the mechanical brake of the elevator, required by law. In the traditional elevators, it is usually installed on the traction machine, with the brake disk or brake drum connected to the brake sheave or motor, and the brake pads connected to the base structure. The brake is normally closed, kept open with the electric current when running; it's status (open or closed) is monitored typically with micro switches that are operated by the movements of the brake pads.

In case of a rope-less linear motor elevator, the mechanical brake needs to move with the cabin in order to be able to stop and hold it at any position. In addition, since rope-less elevators do not have traveling cables, there is no easy method of ensuring a reliable and constant electrical power supply to the cabin, thus an electrically operated brake might experience a momentary power loss. Even a very short power loss could engage the brake and endanger the passengers; on the other hand, it is not permitted to keep the brake current flowing in case its supply is interrupted since that would defeat immediately engaging the brake when needed. We should note that while the signal transfer of the monitor switch of brake operation is also subject to possible interruption, it is possible to arrange the safety operating sequence in such a way that such failures do not endanger safety.

As a result, an improvement needs to be made since present applications cannot solve problems in the technical field.

### The Purpose of the Invention

The invention aims to bring a solution for the negative aspects for a mechanical brake operator system stated above, constructed with the inspiration from the current state of art.

The main object of the invention is to provide a system for mechanical brake operation suitable for linear motor elevators. The system is capable of holding or decelerating the elevator cabin by a mechanical brake that is operated by re-using the existing linear motor stator coils for the secondary purpose of brake operation. The disclosed system provides safe and reliable mechanical braking for single car or multi-car linear motor elevators.

Another object of the invention is to provide a low-cost and reliable brake operating solution for linear motor elevators, using the existing components (stator and mover) of the system.

The structural and characteristic features and all advantages of the invention outlined in the drawings below and in the detailed description made by referring these figures will be understood clearly, therefore the evaluation should be made by taking these figures and detailed explanation into consideration.

### BRIEF DESCRIPTION OF THE FIGURES

FIG. 1 illustrates an overview of the preferred embodiment showing the mechanical brake connected to the main mover and brake mover, with the two movers in the proximate position, and the brake closed (engaged).

FIG. 2 illustrates an overview of the preferred embodiment showing the mechanical brake connected to the main mover and brake mover, with the two movers in the distant position, and the brake open.

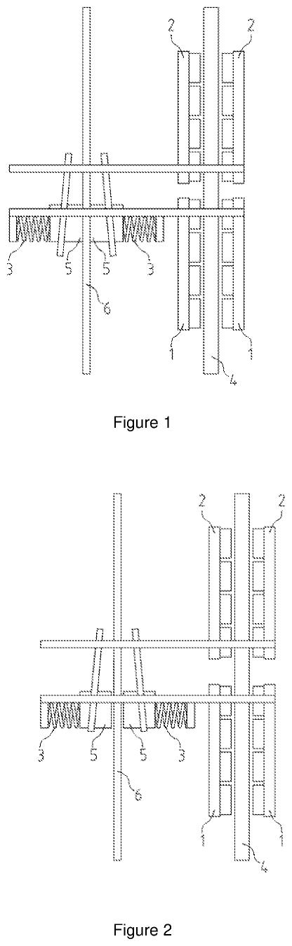

### REFERENCE NUMBERS

1 Main mover
2 Brake mover
3 Brake spring
4 Stator
5 Brake pad
6 Brake plate

### DETAILED EXPLANATION OF THE INVENTION

In this section, the preferred embodiment of the mechanical brake operator system is clarified such that there is no limiting effect for the sake of better understanding the subject. This part is a detailed description of exemplary embodiments to illustrate the principles of the invention.

The invention relates to a mechanical brake operator system providing low-cost and reliable braking without the need of power transmission for rope-less linear motor elevators to be used by single-car or multi-car linear motor elevators operating on linear, curved, or branching trajectories.

The term “mover” is broadly defined to include any device equipped with magnetic poles, capable of interacting with the traveling magnetic field of the linear motor stator (4) coils, and capable of movement along the stator.

The term “linear motor elevator drive” collectively defines the stator or multiple stators, and the mover or multiple movers, together capable of holding and moving an elevator cabin or a multiplicity of elevator cabins.

The term “brake” is a mechanical brake capable of holding a stopped cabin, or optionally decelerating/stopping a moving cabin.

The term “closing spring” is a device capable of exerting a closing force on the brake, sufficient to achieve a brake force required for the normal operation of the brake.

The mechanical brake operator system comprises at least one brake plate (6) and at least two brake pads (5) for each brake plate (6). The brake pads (5) are located on both sides of the brake plate (6).

The brake pads (5) and the brake plate (6) are normally in contact, pressed together by at least one set of brake springs (3). The brake pads (5) provide frictional stopping force by pressure on the stationary brake plate (6). In this way, the brake pads (5) and the brake plate (6) provide a frictional force sufficient to stop and hold the total weight of the elevator cabin. In the illustrated embodiment, the opening/closing mechanism is realized by tilted rails (e.g. linear bearings) arranged in such a way that moving the rails upwards causes the brake pads (5) to move apart from the brake plate (6), against the pressure of the closing brake spring (3). The brake spring (3) provides the passive closing force for the brake mechanism, assuring normally closed operation, even upon loss of power. For this purpose, at least one set of brake springs (3) is used in the mechanical brake operator system. For example, each brake spring (3) is in contact with each brake pad (5). In the alternative embodiment, there is one brake spring (3) acting on both brake pads (5).

The mechanical brake or multiple brakes comprises brake springs (3), brake pads (5) and brake plate (6). These mechanical brake or multiple brakes are installed on at least one linear motor mover which is called as main mover (1) connected to the elevator cabin. The main mover (1) provides thrust force for lifting the cabin by interacting with the magnetic field of the stator (4) coils.

Another mover, called as brake mover (2) is also connected to the mechanical brake and the function of the brake mover (2) is to open or close the mechanical brake mechanism by actively controlling the distance of the brake mover (2) from the main mover (1).

Upon completing the brake opening movement, the brake mover (2) contributes to the cabin lifting together with the main mover (1), the brake mover (2) is controlled independently with the main mover (1).

Stator (4) is electrical coils lined up vertically, to provide operating power to both the main mover (1) and brake mover (2).

When it is required to open the brake and move the cabin, first the stator (4) facing the main mover (1) are energized with sufficient current to hold the cabin and remove its weight from the brake pads (5). Next, the stator (4) segments facing the brake mover (2) are energized, then driven with a current phase schedule to move the brake mover (2) away from the main mover (1) and open the brake mechanism by counteracting the force of the brake springs (3). Upon reaching the fully open position, the brake mover (2) will press against a stopper (not shown in the figures), stops, and takes up part of the weight of the elevator cabin. This completes the brake opening sequence and the elevator is ready to start traveling to its next destination, by energizing the stator (4) segments with currents driving both the main mover (1) and brake mover (2) together. Upon arrival, the above sequence is executed in the reverse direction, by first moving back the brake mover (2) into the vicinity of the main mover (1), thus closing the brake; then de-energizing the stator (4) segments facing the brake mover (2); and finally de-energizing the remaining stator (4) segments and letting the brake take up the weight of the cabin.

The present embodiment of the invention is operated in a sequence controlled by the elevator controller. For a preferred embodiment of the invention, the phases of operation, starting from the stopped state, are the following:
The stator (4) coils facing the main mover (1) are energized with a current sufficient to generate a thrust equivalent to the total cabin weight including the payload and mover self-weights. However, the stator (4) magnetic field is stationary, not moving the mover.
The stator (4) coils facing the brake mover (2) are energized with a current sufficient to generate a thrust to overcome the closing spring force, when acting through the tilted rails.
The brake mover (2) is lifted up to a position where the brake pads (5) are fully disengaged from the brake plate (6). During this opening movement, initially the full weight of the cabin is carried by the main mover (1). However, at the end of the opening movement, the brake mover (2) is stopped by a stopper (not shown in the figures) rigidly connected to the main mover (1), and from that point the main mover (1) and the brake mover (2) jointly carry the weights.
After the brake mechanism is fully open, both the main mover (1) and brake mover (2) are jointly controlled to drive the cabin to the desired new position. Because of the synchronous movement of the main mover (1) and brake mover (2), the speed and position control system can deal with them as a single mover, and it is not necessary to control their motion separately.

The above sequence is executed in the reverse order on reaching the target position, after fully stopping.

The embodiments are provided to illustrate aspects of the invention, but the invention is not limited to any embodiment. In other words, the embodiments disclosed are illustrative, not restrictive.

While specific configurations/embodiments of the mechanical brake operator system have been described, it is understood that the present invention can be applied to a wide variety of elevator systems. The mechanical brake operator system according to the invention is also suitable for non-linear (curved) movement paths of the linear motor elevator, or for movements along branching paths with switches.

There are many alternative ways of implementing the invention, including but not limited to having different mechanisms transferring the movements of the movers to the brake. Numerous specific details are set forth in the description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured. However, many other equivalent mechanisms can be substituted for the illustrated embodiment, among them linkages, rack-and-pinion mechanism, and so on, easily selected by a mechanical engineer.

The scope of the invention encompasses numerous alternatives, modifications, and equivalents; it is defined only by the claims.

In order to fulfill all aims of the invention and solve the problems of the state of art, the invention is a mechanical brake operator system suitable for linear motor elevators, comprising:
at least one mechanical brake attached to the elevator cabin, wherein the mechanical brake comprises
   at least one brake plate (6),
   at least two brake pads (5) for each brake plate (6) and
   at least one set of brake springs (3) in order to press the brake pads (5) and the brake plate (6),
at least one main mover (1) attached to the elevator cabin to provide thrust force for lifting the cabin, and
at least one brake mover (2) attached to the mechanical brake, capable of opening or closing the mechanical brake by actively controlling the distance from the main mover (1).

To solve the problems of the state of art, the invention is a mechanical brake operator system, wherein multiple elevator cabins are installed in the same hoistway, each of multiple elevator cabins is equipped with the mechanical brake, and each of the mechanical brakes is arranged to be driven by the same stator (4) coil.

To solve the problems of the state of art, the invention is a rope-less linear motor elevator system comprising: a mechanical brake, a linear motor drive system, and an elevator cabin.

To solve the problems of the state of art, the invention is a rope-less multi-car linear motor elevator system comprising: a mechanical brake, a linear motor drive system, and a plurality of elevator cabins.

1. A mechanical brake operator system suitable for linear motor elevators, comprising:
at least one mechanical brake attached to an elevator cabin, wherein the mechanical brake comprises:
at least one brake plate;
at least two brake pads for each brake plate; and
at least one set of brake springs in order to press the brake pads and the brake plate;
at least one main mover attached to the elevator cabin to provide thrust force for lifting the cabin; and
at least one brake mover attached to the mechanical brake, capable of opening or closing the mechanical brake by actively controlling a distance from the main mover.

2. A mechanical brake operator system according to claim 1, wherein:
multiple elevator cabins are installed in the same hoistway;
each of the multiple elevator cabins is equipped with the mechanical brake; and
each of the mechanical brakes is arranged to be driven by the same stator coil.

3. A rope-less linear motor elevator system comprising:
a mechanical brake according to claim 1;
a linear motor drive system; and
an elevator cabin.

4. A rope-less multi-car linear motor elevator system comprising:
a mechanical brake according to claim 1;
a linear motor drive system; and
a plurality of elevator cabins.
